(19) United States
(12) Patent Application Publication
(10) Pub. No.: US 2020/0130000 A1
(43) Pub. Date: Apr. 30, 2020

(54) SMALL-CAPACITY LIQUID DISCHARGING APPARATUS

(71) Applicant: MYCELEBS CO., LTD., Seoul (KR)

(72) Inventor: Seon Hye SONG, Gyeonggi-do (KR)

(21) Appl. No.: 16/728,433

(22) Filed: Dec. 27, 2019

Related U.S. Application Data
(63) Continuation of application No. PCT/KR2018/007176, filed on Jun. 25, 2018.

(30) Foreign Application Priority Data
Jun. 29, 2017 (KR) 20-2017-0003385

(51) Int. Cl. B05B 11/00; B65D 83/00

(52) U.S. Cl. CPC B05B 11/0044; B65D 83/0005; B05B 11/3001

(57) ABSTRACT

A small-capacity liquid discharging apparatus includes, a contents accommodating container unit which is defined with a space therein for accommodating contents in a liquid form; an intermediate coupling body which includes a closing plate member coupled to an upper side of the contents accommodating container unit and configured to close an upper portion of the contents accommodating container unit, is defined with a through hole for allowing the contents to move therethrough, and includes a shape body filled therein with the contents from the contents accommodating container unit through the through hole, and transformed inwardly when a pressure is externally applied, and then restored; and a discharge member which is coupled to an upper portion of the intermediate coupling body, includes, at a center portion thereof, a discharge outlet through which the contents are discharged to the outside.

### TECHNICAL FIELD

The present disclosure relates to a small-capacity liquid discharging apparatus, and more particularly, to a small-capacity liquid discharging apparatus that may discharge a small amount of a viscous liquid material, when a user desires.

### DISCUSSION OF RELATED ART

In general, discharge containers are used a lot in order to discharge liquid contents, such as cleaning products, e.g., shampoo and rinse. An example of such a discharging apparatus used for such a liquid discharge container is illustrated in FIG. 1. The liquid discharging apparatus illustrated in FIG. 1 is an apparatus that is coupled to an upper portion of a container that accommodates liquid contents to discharge a certain amount of contents. The liquid discharging apparatus is provided with, at an upper side thereof, a botton 10 which may be raised and lowered up and down, and a nozzle 11 is coupled at the front of the button 10. A shaft 20, which extends vertically, is coupled at a lower side of the button 10, and the shaft 20 is supported by a spring 21. The button 10 is pressed downward to be inserted into a cover 30 which is coupled to an inlet of a cosmetic container, and a securing cap 40 is coupled to an inner side of the cover 30. A lower end portion of the shaft 20 is inserted to an upper side of the securing cap 40, and an upper end portion of a stem 50, of which an outer circumferential surface is coupled to a piston 60, is inserted to a lower side of the securing cap 40 to an inner side of the shaft 20. An upper inner end portion is defined with a transfer space 51 which is open and through which the contents are transferred, and a plurality of through holes 52 communicating with the transfer space 51 are radially defined at a lower outer circumferential surface of the stem 50.

In an embodiment, a housing 80, of which an outer circumferential surface is coupled to a securing ring 31 to be secured at an inner side of the cover 30, is provided at a lower portion of the securing cap 40. The housing 80 is configured so that the shaft 20, the stem 50, and the piston 60 may move up and down inside the housing 80. In addition, an opening and closing member 70 which may move up and down is provided inside the housing 80, and a space 71 which is open upward is provided inside the opening and closing member 70 to improve the elastic force thereof. A head 72, in a hemispherical shape, is formed at a lower side the opening and closing member 70, and a plurality of wing portions 73 are formed radially on an outer circumferential surface of the opening and closing member 70. In addition, air hole 81 is defined at an upper outer circumferential surface of the housing 80, a step portion 82 is formed at an inner lower portion of the housing 80, and a suction hole 83 is defined below the step portion 82. The wing portion 73 of the opening and closing member 70 closely contacts the step portion 82 to serve as a stopper, thereby prevented from moving further upward, and the head 72 is spaced apart from or closely contact the suction hole 83 according to ascending and descending of the opening and closing member 70, thereby opening or closing the suction hole 83. A close contact portion 84 with which the head 72 is in close contact is formed at an inner circumferential surface of an upper end portion of the suction hole 83, and the close contact portion 84 is defined in an arc shape corresponding to the hemispherical shape of the head 72. When the button 10 is pressed downward to discharge the contents from the liquid discharging apparatus configured as described above, the stem 50 and the piston 60 are lowered together and the outside air flows into the housing 80 through the air hole 81. Accordingly, the contents filled between the stem 50 and the opening and closing member 70 are compressed to lower the opening and closing member 70, and the head 72 seals the suction hole 83. In such a case, as the stem 50 descends, a pressure is generated inside the housing 80, thus raising the piston 60, whereby the contents are sucked into the transfer space 51 through the through hole 52, which is open, and are discharged through the nozzle 11.

However, such a conventional liquid discharging apparatus has disadvantages in that it includes a number of parts and the structure is complicated, and hence the manufacturing cost may be increased, and the cost of the finished product filled with the contents may become quite expensive. In addition, in such a structure to suck up the liquid upward, which is filled at a lower portion of the container, and discharge the liquid outside, there is a disadvantage that part of contents, located at the bottom of the container, below an insertion tube for sucking up the contents, is left and thus the contents may not be completely used up.

### SUMMARY

Aspects of embodiments of the present disclosure provides a small-capacity liquid discharging apparatus in which discharge of a viscous liquid material is facilitated to promote convenience, contents may be used up completely, and the number of parts is reduced to reduce the manufacturing cost.

### Technical Solution to the Problem

According to an embodiment, a small-capacity liquid discharging apparatus includes, a contents accommodating container unit, in a cylindrical shape, which is defined with a space therein for accommodating contents in a liquid form; an intermediate coupling body which includes a closing plate member coupled to an upper side of the contents accommodating container unit and configured to close an upper portion of the contents accommodating container unit, is defined with, at a center portion of the closing plate member, a through hole for allowing the contents to move therethrough, and includes a shape body coupled to an upper portion of the closing plate member, filled therein with the contents from the contents accommodating container unit through the through hole, and transformed inwardly when a pressure is externally applied, and then restored; and a discharge member which is coupled to an upper portion of the intermediate coupling body, includes, at a center portion thereof, a discharge outlet through which the contents are discharged to the outside, and includes, at a lower end of the discharge outlet, a check valve configured to allow the contents filled in the shape body to move to the discharge outlet and prevent the contents from moving downward.

As the shape body is pressed by an external force, the contents filled in the shape body is discharged to the discharge outlet through the check valve, and when the external force is removed, the shape body is restored and the contents from the contents accommodating container unit are filled again in the shape body.

In an embodiment, the contents accommodating container unit is provided with, thereinside, a support plate configured to support the contents and coupled to an inner circumferential surface of the contents accommodating container unit to be movable up and down in the contents accommodating container unit in accordance with movement of the contents when the contents are discharged upward, and defined with a vent hole at a bottom surface to allow air from being introduced from the outside as the support plate rises.

In an embodiment, a check valve configured to allow air to be introduced and prevents air from being discharged is provided at the vent hole defined at the bottom surface of the contents accommodating container unit.

In an embodiment, a support foot configured to prevent the support plate from moving downward on an inner circumferential surface of the contents accommodating container unit is coupled to a lower portion of the support plate by a coupling member, and an end portion of the support foot includes a plurality of end portions which extend radially to contact the inner circumferential surface of the contents accommodating container unit.

In an embodiment, an inner close contact portion which is in close contact with an upper inner side of the contents accommodating container unit is formed at a lower portion of the closing plate member, and a recess, in a circular shape, corresponding to the inner close contact portion of the closing plate member is defined at an upper circumference of the support plate in a circumferential direction.

In an embodiment, the contents accommodating container unit is in a pouch shape of which an internal volume is reduced when the contents are discharged upward.

In an embodiment, a check valve configured to allow the contents to move upward and prevents the contents from moving downward is provided at the vent hole defined at the center portion of the closing plate member.

In an embodiment, an upper portion of the contents accommodating container unit and a lower edge of the closing plate member of the intermediate coupling body are formed with respective screw portions to be screwed with each other, and vertical recesses are defined at threads of the screw portions, respectively, so that air between the intermediate coupling body and the contents accommodating container unit is easily discharged to the outside when the intermediate coupling body and the contents accommodating container unit are coupled to each other.

In an embodiment, a concave recess is defined at an upper end of the contents accommodating container unit in a circumferential direction, and a protrusion corresponding to the concave recess is formed at a lower surface of the closing plate member in a circumferential direction so that the protrusion is engaged with the concave recess when coupling between an upper portion of the contents accommodating container unit and a lower edge of the closing plate member of the intermediate coupling body is completed.

In an embodiment, an annular rib is unitarily formed at an inner circumferential surface of the shape body of the intermediate coupling body along a circumferential direction.

In an embodiment, an upper cap is coupled to an upper portion of the discharge member to be opened and closed, and a sealing member, in a circular shape, configured to seal the discharge outlet by being inserted into the discharge outlet of the discharge member when the discharge member is coupled to the upper cap, is coupled to a center portion of a lower surface of the upper cap so as to prevent the contents of the contents accommodating container unit from being discharged to the outside due to a pressure change.

In an embodiment, the shape body is coupled to an upper edge of the closing plate member and is formed in a cylindrical shape, thus capable of being pressed in all directions.

In an embodiment, a flow tube configured to guide the contents to move toward the discharge outlet of the discharge member is provided at an upper portion of the closing plate member in the shape body of the intermediate coupling body, and a flow hole which allows the contents to move into and out of the flow tube is defined at an outer circumferential surface of the flow tube.

In an embodiment, a support leg extending from an inner circumferential surface of the shape body to the flow hole of the flow tube is unitarily formed with the shape body, and the support leg closes the flow hole of the flow tube in a normal state, and when the shape body is pressed by an external force, the support leg is separated from the flow hole so that the contents flow through the flow hole.

In an embodiment, an opening and closing portion configured to open and close the flow hole is provided, the opening and closing portion coupled to an outer circumferential surface of the flow tube, the opening and closing portion includes an opening and closing member rotatably coupled to the outer circumferential surface of the flow tube to open and close the flow hole, and a handle of which one end portion is coupled to the opening and closing member and of which another end portion extends to be exposed to the outside of the small-capacity liquid discharging apparatus, and the flow hole of the flow tube is opened and closed by rotation of the handle.

In an embodiment, the flow hole includes a plurality of flow holes along a circumferential direction of the flow tube, and the number of the plurality of flow holes, defined along the circumferential direction of the flow tube, that are opened by the opening and closing member is changed according to a rotation angle of the handle.

In an embodiment, the shape body is coupled to one side of an outer circumferential surface of the intermediate coupling body and communicates with the flow hole of the flow tube.

In an embodiment, an outer circumferential surface of the shape body includes a corrugated pipe.

In an embodiment, an adjustment cover is coupled to an outer portion of the shape body, a guide recess for guiding the adjustment cover to move inwardly is defined at the intermediate coupling body to which the shape body is coupled to, and a coupling protrusion formed at one side of an outer circumferential surface of the adjustment cover moves along the guide recess.

In an embodiment, a rotation recess extending along a circumferential direction of the shape body is connected to a front end of the guide recess so as to rotate the adjustment cover, and when the apparatus is not in use, the coupling protrusion of the adjustment cover is separated from the guide recess to be located at the rotation recess so as to prevent the adjustment cover from moving inward.

### Effects of the Invention

According to the present disclosure, a small-capacity liquid discharging apparatus in which discharge of liquid contents is facilitated to promote convenience, contents may be used up completely, and the number of parts is reduced to reduce the manufacturing cost is provided.

### BRIEF DESCRIPTION OF THE DRAWING PORTIONS

FIG. 1 is a cross-sectional view illustrating a conventional liquid discharge container.

FIG. 2 is a perspective view illustrating a small-capacity liquid discharging apparatus according to a first embodiment of the present disclosure.

FIG. 3 is a cross-sectional view illustrating the small-capacity liquid discharging apparatus according to the first embodiment of the present disclosure.

FIG. 4 is a detailed view illustrating part A in FIG. 3.

FIG. 5 is an operation diagram illustrating the small-capacity liquid discharging apparatus according to the first embodiment of the present disclosure.

FIG. 6 is a cross-sectional view illustrating a small-capacity liquid discharging apparatus according to a second embodiment of the present disclosure.

FIG. 7 is a cross-sectional view illustrating a small-capacity liquid discharging apparatus according to a third embodiment of the present disclosure.

FIG. 8 is a cross-sectional view illustrating a small-capacity liquid discharging apparatus according to a fourth embodiment of the present disclosure.

FIG. 9 is a cross-sectional view illustrating a small-capacity liquid discharging apparatus according to a fifth embodiment of the present disclosure.

FIG. 10 is an operation diagram illustrating the small-capacity liquid discharging apparatus according to the fifth embodiment of the present disclosure.

FIG. 11 is a cross-sectional view illustrating a small-capacity liquid discharging apparatus according to a sixth embodiment of the present disclosure.

FIG. 12 is a plan view illustrating a flow tube and an opening and closing member in FIG. 11.

FIG. 13 is a view illustrating an operating state of the opening and closing member in FIG. 12.

FIG. 14 is an operation diagram illustrating the small-capacity liquid discharging apparatus according to the sixth embodiment of the present disclosure.

FIG. 15 is a cross-sectional view illustrating a small-capacity liquid discharging apparatus according to a seventh embodiment of the present disclosure.

FIG. 16 is an operation diagram illustrating the small-capacity liquid discharging apparatus according to the seventh embodiment of the present disclosure.

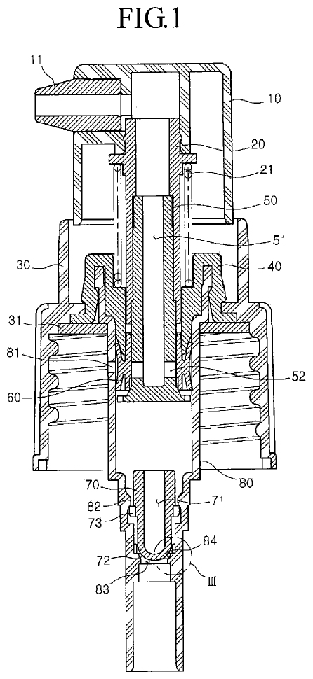

### PREFERRED EMBODIMENTS OF THE INVENTION

Hereinafter, a small volume liquid discharging apparatus according to preferred embodiments of the present disclosure will be described in detail with reference to the drawings.

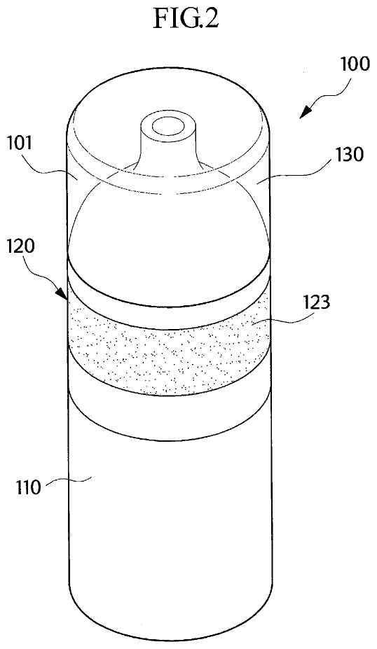

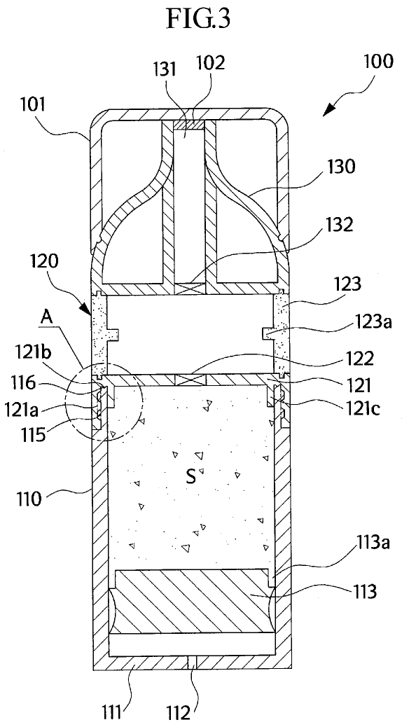

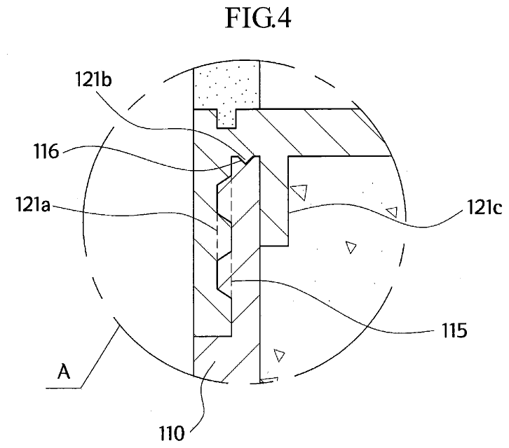

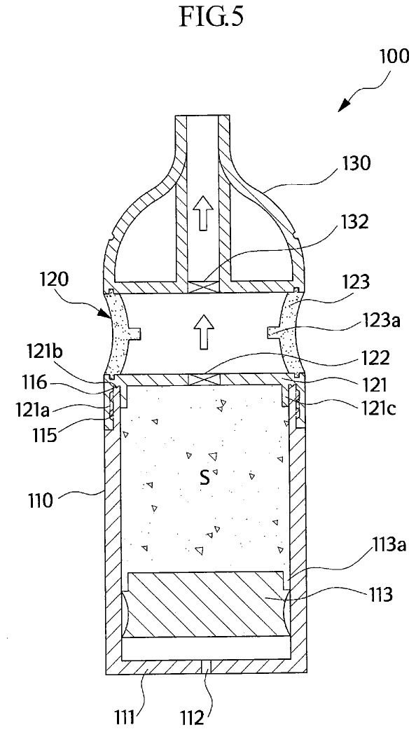

FIG. 2 is a perspective view illustrating a small-capacity liquid discharging apparatus according to a first embodiment of the present disclosure, FIG. 3 is a cross-sectional view illustrating the small-capacity liquid discharging apparatus according to the first embodiment of the present disclosure, FIG. 4 is a detailed view illustrating part A in FIG. 3, and FIG. 5 is an operation diagram illustrating the small-capacity liquid discharging apparatus according to the first embodiment of the present disclosure.

First, a small-capacity liquid discharging apparatus 100 according to a first embodiment of the present disclosure includes: a contents accommodating container unit 110 which is formed at a lower portion of the small-capacity liquid discharging apparatus 100 and accommodates liquid contents such as a foundation cream therein; an intermediate coupling body 120 including a shape body 123 which is coupled to an upper portion of the contents accommodating container unit 110 to close the upper portion of the contents accommodating container unit 110 and transformed inwardly when pressed and then restored thereafter; and a discharge member 130 coupled to an upper portion of the intermediate coupling body 120.

The contents accommodating container unit 110, in a cylindrical shape, is defined therein with a space for accommodating liquid contents S and is defined with a vent hole 112 at a bottom surface 111 thereof, through which air is introduced. The inside of the contents accommodating container unit 110 is provided with a support plate 113 for supporting the contents S, and the support plate 113 is coupled to an inner circumferential surface of the contents accommodating container unit 110 to be movable up and down. As the contents moves upward, the support plate 113 rises in the contents accommodating container unit 110. As such, the support plate 113 rises toward a closing plate member 121 as the contents S are discharged, and a circular recess 113a corresponding to an inner close contact portion 121c of the closing plate member 121 is defined at an upper edge of the support plate 113 in a circumferential direction so that the contents S may be completely used up. In the present embodiment, the contents accommodating container unit 110 is formed of or includes a hard plastic material having a constant shape, but in another embodiment, a body portion except for a screw portion engaged with the intermediate coupling body 120 may include a pouch or tube that is reduced in terms of volume as the contents S are discharged. In such a case, the support plate 113 and the vent hole 112 are not formed.

An upper portion of the contents accommodating container unit 110 is screwed with a lower portion of the closing plate member 121 of the intermediate coupling body 120. To this end, a screw portion, in a shape of a trapezoidal thread, is formed at an upper outer circumferential surface of the contents accommodating container unit 110 in a circumferential direction to be screwed with a lower edge of the closing plate member 121 of the intermediate coupling body 120, and a vertical recess 115 is formed at intervals of 90 degrees along a circumferential direction at the trapezoidal thread. When the contents accommodating container unit 110 is coupled to the intermediate coupling body 120, air between an upper surface of the contents S of the contents accommodating container unit 110 and the closing plate member 121 of the intermediate coupling body 120 remains and is mixed with the contents, thus possibly resulting in improper operation of the container. In the present disclosure, vertical recesses 115, 121a are defined at the upper portion of the contents accommodating container unit 110 and the lower portion of the closing plate member 121, respectively, as described above, so that the air may be easily discharged when the intermediate coupling body 120 is coupled, thereby preventing such problems. In addition, a concave recess 116, in a triangular shape, is defined at an upper end of the contents accommodating container unit 110 in a circumferential direction, and a protrusion 121b of the closing plate member 121, to be described below, is coupled to the concave recess 115 after screw coupling between the contents accommodating container unit 110 and the closing plate member 121 of the intermediate coupling body 120 is completed.

The intermediate coupling body 120 is coupled to the contents accommodating container unit 110 which is formed therebelow, and includes the closing plate member 121, a first check valve 122 formed at a center portion of the closing plate member 121, and a shape body 123 in a cylindrical shape.

The closing plate member 121 of the intermediate coupling body 120 is formed in a disc shape to close the upper portion of the contents accommodating container unit 110, and a through-hole is defined at a center portion of the closing plate member 121, through which the contents S may move. At the through-hole, the first check valve 122 is provided at a center portion of the closing plate member 121. The first check valve 122 is configured to allow the contents to move from the contents accommodating container unit 110 to the above of the closing plate member 121 and to prevent the contents from moving in an opposite direction, i.e. downward. In addition, as illustrated in FIG. 4, the protrusion 121b, in a triangular shape, corresponding to the concave recess 115 is formed at an edge of a lower surface of the closing plate member 121 in a circumferential direction so that the protrusion 121b may be coupled with the concave recess 115 defined at the upper end of the contents accommodating container unit 110 when the coupling with the contents accommodating container unit 110 is completed. Air is drawn out through the vertical recesses 115 and 121a of respective screw portions of the lower edge of the closing plate member 121 of the intermediate coupling body 120 and the contents accommodating container unit 110 while the intermediate coupling body 120 is coupled to the contents accommodating container unit 110, and when the coupling is completed, the protrusion 121b of the closing plate member 121 is coupled to the concave recess 116 of the contents accommodating container unit 110 to completely seal the contents accommodating container unit 110.

A lower edge portion of the closing plate member 121 protrudes downward from an edge of the closing plate member 121 to couple the intermediate coupling body 120 to the contents accommodating container unit 110, and a screw portion is formed at an inner circumferential surface of the lower edge portion of the closing plate member 121 to be screwed with an upper portion of the contents accommodating container unit 110. In addition, a vertical recess 121a is defined, at intervals of 90 degree, at a thread of the screw portion formed at the lower edge of the closing plate member 121 in a circumferential direction, similar to the vertical recess 115 of the upper screw portion of the contents accommodating container unit 110. In addition, the inner close contact portion 121c, in a circular shape, is formed to closely contact an upper inner side of the contents accommodating container unit 110 when the closing plate member 121 is screwed with the upper portion of the contents accommodating container unit 110.

In addition, the shape body 123 is coupled to an upper edge of the closing plate member 121. The shape body 123, in a cylindrical shape, is formed over the entire circumference of an outer circumferential surface of the intermediate coupling body 120, and includes a flexible synthetic resin material that may be transformed inwardly when externally pressed and is restorable. A lower edge of the shape body 123, in a cylindrical shape, is coupled to the upper edge portion of the closing plate member 121, and the inside of the shape body 123 is filled with the contents having moved through the first check valve 122 from the contents accommodating container 110. Accordingly, for example, when pressing the shape body 123 with two fingers, as illustrated in FIG. 5, the shape body 123 is transformed inwardly, and thus the contents filled in the shape body 123 moves to the discharge outlet 131 through a second check valve 132. As the present invention has the above-described configuration, it is possible to press the shape body 123 in all (e.g., omni-directional) directions, thus facilitating discharge of the contents.

In addition, an annular (e.g., ring-shaped) rib 123a is formed unitarily with an inner circumferential surface of the shape body 123 along a circumferential direction, and the annular rib 123a serves the shape body 123 to return to its original state from the transformed state due to the externally applied pressure. The discharge member 130 is coupled to an upper portion of the intermediate coupling body 120 to guide the discharge of the contents. A discharge outlet 131 which allows the contents to be discharged to the outside is formed at a center portion of the discharge member 130, and a second check valve 132 which allows the contents to move from the inside of the shape body 123 to the discharge outlet 131 and prevents the contents from moving in an opposite direction is provided at a lower end portion of the discharge outlet 131. A silicon tip, a brush, or a puff cotton may be coupled to an upper portion of the discharge outlet 131.

An upper cap 101 which may be opened and closed is coupled to the upper portion of the discharge member 130. In the present embodiment, a sealing member 102, in a circular shape, for sealing the discharge outlet 131 of the discharge member 130 is provided at a center portion of a lower surface of the upper cap 101. The sealing member 102 is configured to prevent the liquid contents S of the contents accommodating container unit 110 from leaking to the outside when the external pressure changes. In the present embodiment, the sealing member 102, in a circular shape, is coupled to the lower surface of the upper cap 101 so that the sealing member 102 is coupled to the discharge outlet 131 in an insertion manner to seal the discharge outlet 131 when coupled to the upper cap 101, such that even in a decompression state, such as air transport, the liquid contents S may be prevented from being discharged to the outside.

Hereinafter, a method of operating the small-capacity liquid discharging apparatus 100 according to the first embodiment of the present disclosure configured as described above will be described with reference to FIG. 5.

In the small-capacity liquid discharging apparatus 100 according to the first embodiment of the present disclosure, in a state where the upper cap 101 is opened from the discharge member 130, a user grips the shape body 123 and applies a pressure on it to discharge the liquid contents S, e.g., cosmetic liquid contents, accommodated in the contents accommodating container unit 110, from the container, the shape body 123 is transformed inwardly, and accordingly, the contents filled in the shape bod 123 move to the discharge outlet 131 through the second check valve 132 and are discharged to the outside. In such a case, since the shape body 123 is formed in a cylindrical shape over the entire outer circumferential surface of the intermediate coupling body 120, it is possible to press the shape body 123 in all directions, thus facilitating discharge of the contents. When the external pressure is removed after the contents are discharged and used, the shape body 120 returns to its original state by a restoring force. When the shape body 123 is restored to its original state, the contents are filled in the shape body 123 once again from the contents accommodating container unit 110 through the first check valve 122, and the support plate 113 is raised in the contents accommodating container unit 110 by an amount of the filled contents. In addition, as the support plate 113 is raised, air is introduced from the outside through the vent hole 112 defined at the bottom surface 111 of the contents accommodating container unit 110.

Accordingly, by such a configuration, the user may easily discharge the contents S, and the contents may be used until the contents are completely used up as the support plate 113 moves upward to the upper portion of the contents accommodating container unit 110.

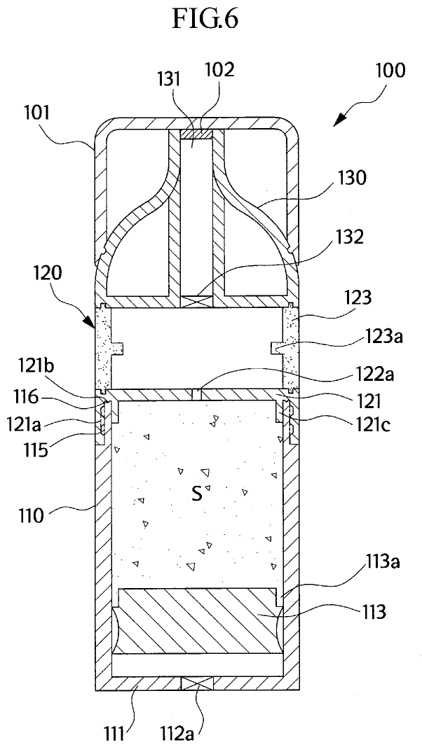

Next, a small-capacity liquid discharging apparatus 100 according to a second embodiment of the present disclosure will be described. FIG. 6 is a cross-sectional view illustrating a small-capacity liquid discharging apparatus 100 according to a second embodiment of the present disclosure.

The small-capacity liquid discharging apparatus 100 according to the second embodiment is different from that of the first embodiment in that a through hole 122a, instead of the first check valve 122, through which the contents move is defined at the center portion of the closing plate member 121 and that a check valve 112a, instead of the vent hole 112, which allows an outside air to be introduced into the contents accommodating container unit 110, while preventing air from flowing in an opposite direction, is formed at the bottom surface 111 of the contents accommodating container unit 110.

Accordingly, in the second embodiment of the present invention, when the shape body 123 is pressed to discharge the contents S, the check valve 112a formed at the bottom surface 111 of the contents accommodating container unit 110 prevents air between the support plate 113 and the bottom surface 111 from being discharged outside, thereby preventing descending of the support plate 113, and further, the contents S in the shape body 123 is not again introduced to the contents accommodating container unit 110 through the through hole 122a, and instead, is discharged through the discharge outlet 131.

In addition, as the check valve 112a is provided at the bottom surface 111 of the contents accommodating container unit 110, even if the contents S are leaked between the support plate 113 and the inner circumferential surface of the contents accommodating container unit 110, the present embodiment has an advantage that the leakage of the contents S to the outside of the container is prevented through the use of the check valve 112a. Other configurations and effects are the same as those in the first embodiment.

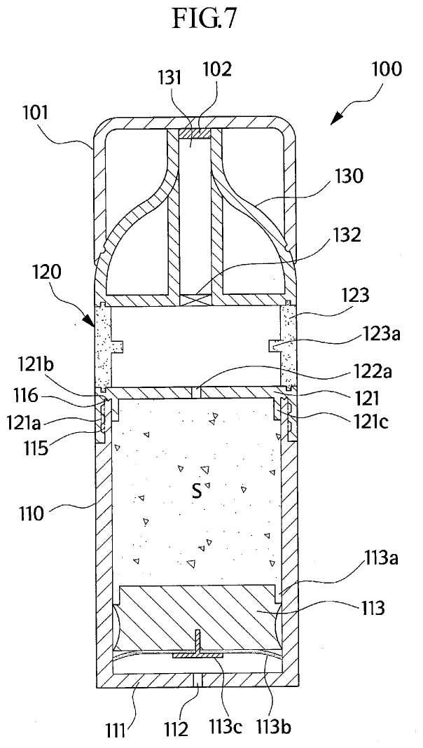

Next, a small-capacity liquid discharging apparatus 100 according to a third embodiment of the present disclosure will be described. FIG. 7 is a cross-sectional view illustrating a small-capacity liquid discharging apparatus 100 according to a third embodiment of the present disclosure. The small-capacity liquid discharging apparatus 100 according to the third embodiment is different from that of the first embodiment in that the through hole 122a, instead of the first check valve 122, through which the contents S move is defined at the center portion of the closing plate member 121 and that a support foot 113b is coupled to a lower portion of the support plate 113. In the present embodiment, the support foot 113b is formed of or includes a metal material and serves to prevent the support plate 113, which supports the contents S, from moving downwards in the contents accommodating container unit 110, when pressing the shape body 123. The support foot 113b extends radially outward from a center portion thereof, and end portions of the plurality of support feet 113b are curved downward to contact the inner circumferential surface of the contents accommodating container unit 110. In addition, the center portion of the support foot 113b is coupled to a lower portion of the support plate 113 by a coupling member 113c.

Accordingly, in the third embodiment of the present disclosure, when pressing the shape body 123 to discharge the contents S, the support foot 113b which is coupled to the lower portion of the support plate 113 prevents the support plate 113 from descending by contacting the inner circumferential surface of the contents accommodating container unit 110 and supporting the support plate 113, and the contents S in the shape body 123 is not introduced back into the contents accommodating container unit 110 through the through hole 122a and is discharged through the discharge outlet 131.

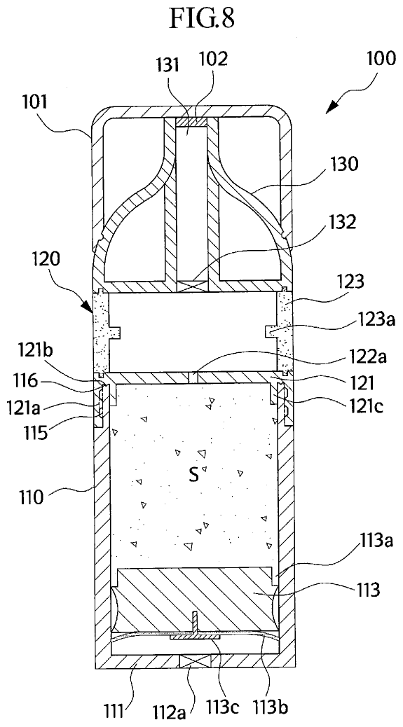

In an embodiment, FIG. 8 illustrates a fourth embodiment in which the check valve 112a which allows the inflow of air from the outside into the contents accommodating container unit 110 and prevents the outflow of air in an opposite direction is provided at a portion corresponding to the vent hole 112 defined at the bottom surface 111 of the contents accommodating container unit 110 with respect to the third embodiment illustrated in FIG. 3. In the fourth embodiment, as the check valve 112a is provided at the bottom surface 111 of the contents accommodating container unit 110, even if the contents S are leaked to a portion between the support plate 113 and the inner circumferential surface of the contents accommodating container unit 110, the leakage of the contents S to the outside of the container is prevented due to the check valve 112a, and further, the check valve 112a prevents air between the support plate 113 and the bottom surface 111 from flowing to the outside, such that the support plate 113 is supported more firmly by the air along with the support foot 113b, thus preventing descending of the support plate 113, when the shape body 123 is pressed.

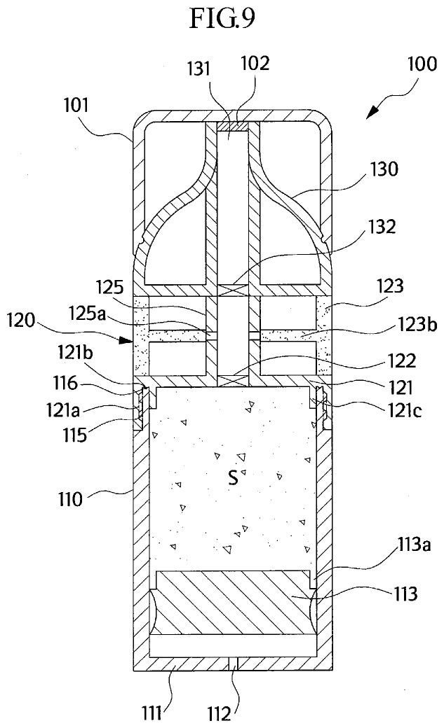

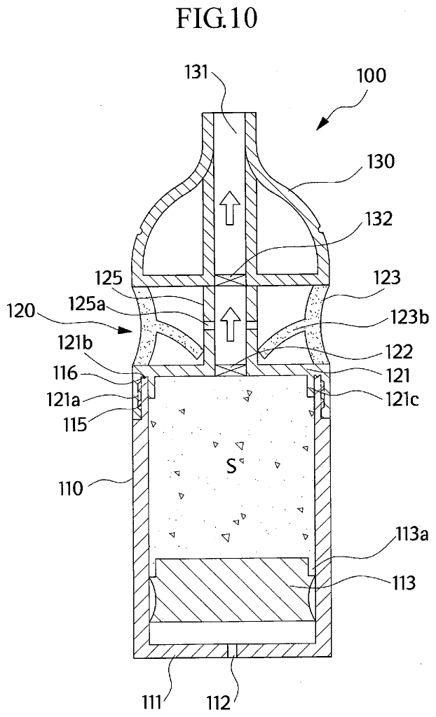

Hereinafter, a small-capacity liquid discharging apparatus 100 according to a fifth embodiment of the present disclosure will be described. FIG. 9 is a cross-sectional view illustrating a small-capacity liquid discharging apparatus 100 according to a fifth embodiment of the present disclosure, and FIG. 10 is an operation diagram illustrating the small-capacity liquid discharging apparatus 100 according to the fifth embodiment of the present disclosure.

The small-capacity liquid discharging apparatus 100 according to the fifth embodiment is different from that of the first embodiment in that a flow tube 125 for guiding movement of the contents S are formed in the intermediate coupling body 120 and that a support leg 123b is formed at an inner circumferential surface of the shape body 123.

The flow tube 125 is coupled to an upper portion of the closing plate member 121 and extends from the first check valve 122 to the second check valve 132 to guide the movement of the contents. In addition, a plurality of flow holes 125a through which the contents move into and out of the flow tube 125 are defined at the outer circumferential surface of the flow tube 125 to be spaced apart at regular intervals along a circumferential direction.

The support leg 123b is formed in an annular shape integrated with the shape body 123 into a unitary structure and is formed over an entire inner circumferential surface along a circumferential direction of the shape body 123 to open and close the flow hole 125a, while serving to support and restore the shape body 123. The support leg 123b extends from the inner circumferential surface of the shape bod 123 to the flow hole 125a of the flow tube 125.

Accordingly, in the fifth embodiment of the present disclosure, in a normal state that the apparatus is not used, the support leg 123b of the shape body 123 closes the flow hole 125a of the flow tube 125, and when the shape body 123 is pressed with a certain force or greater, the support leg 123b is bent to be separated from the flow hole 125a, as illustrated in FIG. 10. Then, the contents S between the flow tube 125 and the shape body 123 move into the flow tube 125 through the flow hole 125a, and then the contents S in the flow tube 125 are discharged to the discharge outlet 131 through the second check valve 132. Next, if the pressure to the shape body 123 is removed, the support leg 123b closes the flow hole 125a again, and at a time, the shape body 123 returns to its original state.

Accordingly, in the present embodiment, the support leg 123b extends from the inner circumferential surface of the shape body 123 to the flow tube 125, thus closing the flow hole 125a and also strengthening a support force of the shape body 123, such that the contents S are prevented from being discharged when the shape body 123 is accidentally pressed by a foreign object, and only when the pressure is greater than a predetermined force, the flow hole 125a is open and the contents S are discharged at the same time. Accordingly, the contents S may be used more safely.

In addition, in a normal state, an end portion 123b of the support leg is supported by the flow tube 125, such that the support and restoration of the shape body 123 may become more smoothly. Other configurations and effects are the same as those in the first embodiment, and the configurations mentioned in the second, third and fourth embodiments are also applicable to the present embodiment.

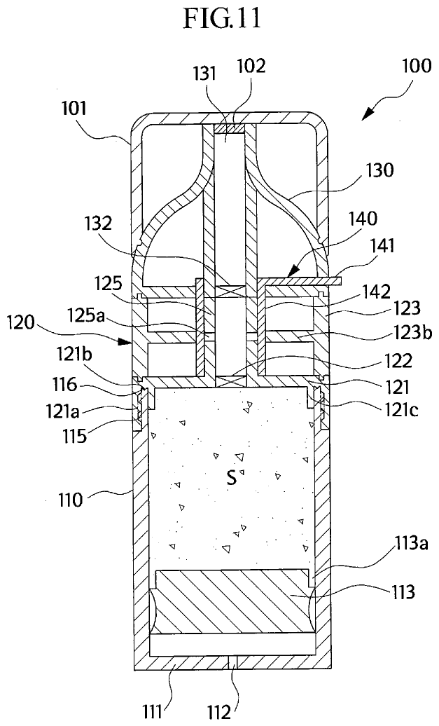

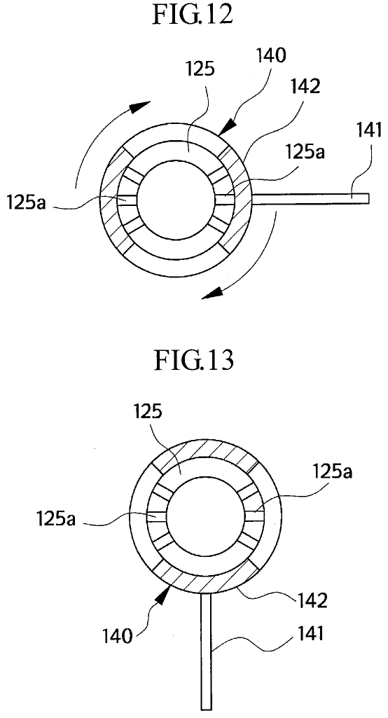

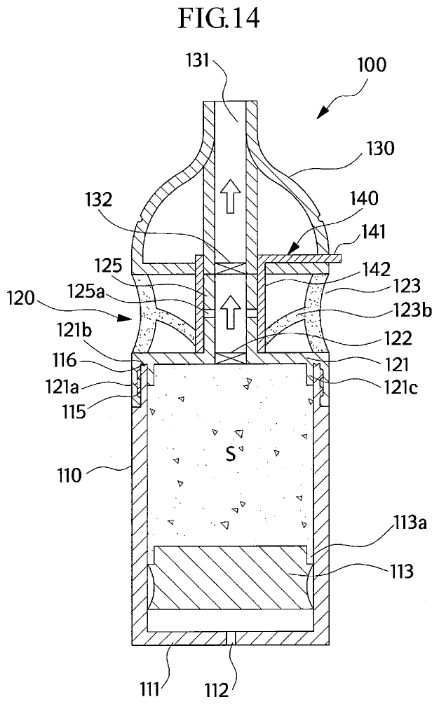

Next, a small-capacity liquid discharging apparatus 100 according to a sixth embodiment of the present disclosure will be described. FIG. 11 is a cross-sectional view illustrating a small-capacity liquid discharging apparatus 100 according to a sixth embodiment of the present disclosure. FIG. 12 is a plan view illustrating a flow tube 125 and an opening and closing member 142 in FIG. 11. FIG. 13 is a view illustrating an operating state of the opening and closing member 142 in FIG. 12. FIG. 14 is an operation diagram illustrating the small-capacity liquid discharging apparatus 100 according to the sixth embodiment of the present disclosure.

The small-capacity liquid discharging apparatus 100 according to the sixth embodiment is different from that of the fifth embodiment in that an opening and closing portion 140 for opening and closing the flow hole 125a of the flow tube 125 is provided. In the present embodiment, the opening and closing portion 140 is engaged with an outer circumferential surface of the flow tube 125 to open and close the flow hole 125a, and includes an opening and closing member 142 rotatably coupled to the outer circumferential surface of the flow tube 125, and a handle 141 one end portion of which is coupled to the opening and closing member 142 and another end portion of which extends to be exposed to the outside of the small-capacity liquid discharging apparatus 100.

The opening and closing member 142 is coupled to surround the flow tube 125 at the outer circumferential surface of the flow tube 125 and serves to open or close the flow hole 125a depending on rotation of the handle 141. The opening and closing member 142 is formed at opposite sides of the flow tube 125, as illustrated in FIG. 12, and upper end portions of the opposite sides of the opening and closing member 142 are connected to each other in a ring shape.

With respect to the operation process of the opening and closing member 142 in the present embodiment, if desired to discharge the contents in a state that the opening and closing member 142 closes the flow hole 125a of the flow tube 125, as illustrated in FIG. 12, the state is converted into a state where the opening and closing member 142 opens the flow hole 125a of the flow tube 125 by rotating the handle 141 exposed to the outside of the discharging apparatus 100, as illustrated in FIG. 13, and then the shape body 123 is pressed to discharge the contents.

Accordingly, in the present embodiment, when the discharging apparatus 100 is not used, the state where the opening and closing member 142 closes the flow hole 125a of the flow tube 125 is maintained, and thus the case where the shape body 123 is accidently pressed and the contents are discharged may be prevented. In addition, in the present embodiment, it is possible to finely adjust a discharge amount of the contents. That is, the number of the flow holes 125a being opened by the opening and closing member 142 is changed according to a rotation angle of the handle 141, and thus discharge amount may be finely adjusted by adjusting the number of opened flow holes 125a.

Other configurations and effects are the same as those in the previous embodiment, and the configurations mentioned in the second, third and fourth embodiments are also applicable.

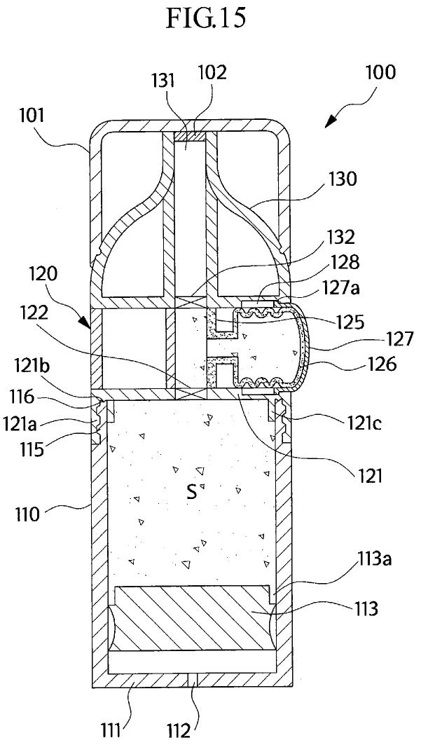

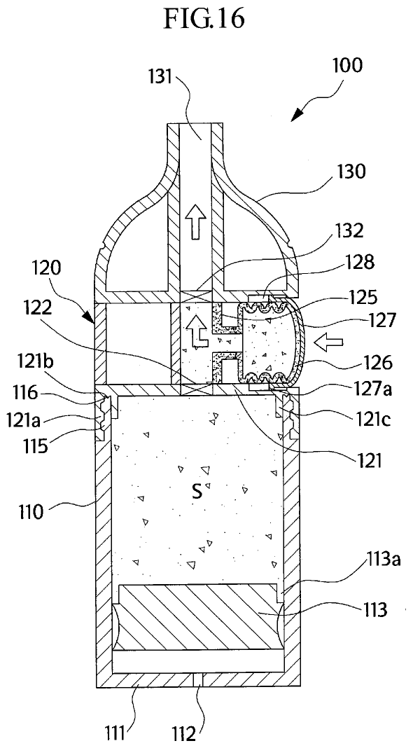

Next, a small-capacity liquid discharging apparatus 100 according to the seventh embodiment of the present disclosure will be described. FIG. 15 is a cross-sectional view illustrating a small-capacity liquid discharging apparatus 100 according to a seventh embodiment of the present disclosure, and FIG. 16 is an operation diagram illustrating the small-capacity liquid discharging apparatus 100 according to the seventh embodiment of the present disclosure.

The small-capacity liquid discharging apparatus 100 according to the seventh embodiment is different from that of the previous embodiments in that a shape body 126 is coupled to one side of an outer circumferential surface of the intermediate coupling body 120, instead of being formed over the entire circumference of the intermediate coupling body 120, and an adjustment cover 127 is coupled to the outside of the shape body 126.

In the present embodiment, the shape body 126 is configured such that an outer circumferential surface of the shape body 126 is in a shape of a corrugated pipe to be compressed and restorable. The shape body 126 is coupled to one side of an outer circumferential surface of the intermediate coupling body 120 and communicates with the flow tube 125 which extends from the first check valve 122 to the second check valve 132.

In addition, the adjustment cover 127 coupled to the outside of the shape body 126 is configured to transmit a pressing force to the shape body 126, when externally pressed, and to prevent the contents from being discharged when the shape body 126 is accidentally pressed, when the discharging apparatus 100 is not in use. The adjustment cover 127 is coupled to cover a front end portion of the shape body 126 that is exposed to the outside. A guide recess 128 which guides the adjustment cover 127 to move inwardly of the discharging apparatus 100 when the adjustment cover 127 is externally pressed is defined at the intermediate coupling body 120 or a lower portion of the discharge member 130 to which the shape body 126 is coupled, and a coupling protrusion 127a formed at one side of an outer circumferential surface of the adjustment cover 127 moves along the guide recess 128 such that the adjustment cover 127 moves inward.

In addition, a rotation recess (not illustrated) which is formed extending along a circumferential direction of the shape body 126 is connected to a front end of the guide recess 128 so as to rotate the adjustment cover 127. The rotation recess is for rotating the adjustment cover 127 in a circumferential direction, not in an inward direction of the discharging apparatus 100, so that the contents are prevented from being discharged when the adjustment cover 127 is accidently pressed when the discharging apparatus 100 is not used. The rotation recess is formed around the shape body 126 at the intermediate coupling body 120 or at a lower portion of the discharge member 130, and an end portion of the rotation recess communicates with the guide recess 128. Accordingly, when the discharging apparatus 100 is not used, the adjustment cover 127 is rotated so that the coupling protrusion 127a is located at the rotation recess from the guide recess 128. Accordingly, the adjustment cover 127 may not move inward, and the contents are prevented from being wrongly discharged when discharging apparatus 100 is not in use.

When the discharging apparatus 100 is used, the adjustment cover 127 is rotated so that the coupling protrusion 127a is located at the guide recess 128 to move inward. In such a case, when the adjustment cover 127 is pressed, the coupling protrusion 127a moves inwardly of the apparatus along the guide recess 128, and accordingly, the corrugated pipe of the shape body 126 is compressed, and the contents in the shape body 126 are discharged to the discharge outlet 131 via the second check valve 132 through the flow tube 125. Next, when the external force is removed, the shape body 126 is restored, and the contents are filled in the shape body 126 again through the first check valve 122.

Other configurations and effects are the same as those in the previous embodiment, and the contents accommodating container unit 110 may also be in the form of a pouch. Similarly, the configurations mentioned in the second, third and fourth embodiments may also be applicable.

Although the present disclosure described above has been described with reference to the illustrated drawings, it is apparent for those in the pertinent art that the present disclosure is not limited to the described embodiments and that it can be variously modified and changed without departing from the spirit and scope of the present disclosure. Therefore, it should be understood that modifications or variations as such belong to the scope of claims of the present disclosure, and the scope of the invention should be interpreted based on the appended claims.

### INDUSTRIAL APPLICABILITY

The small-capacity liquid discharging apparatus according embodiments of the present disclosure facilitates discharge of liquid contents to promote user's convenience, the contents may be completely used up, and the number of parts is reduced to reduce manufacturing costs.

What is claimed is:

1. A small-capacity liquid discharging apparatus, comprising:
a contents accommodating container unit, in a cylindrical shape, which is defined with a space therein for accommodating contents in a liquid form;
an intermediate coupling body which comprises a closing plate member coupled to an upper side of the contents accommodating container unit and configured to close an upper portion of the contents accommodating container unit, is defined with, at a center portion of the closing plate member, a through hole for allowing the contents to move therethrough, and comprises a shape body coupled to an upper portion of the closing plate member, filled therein with the contents from the contents accommodating container unit through the through hole, and transformed inwardly when a pressure is externally applied, and then restored; and
a discharge member which is coupled to an upper portion of the intermediate coupling body, comprises, at a center portion thereof, a discharge outlet through which the contents are discharged to the outside, and comprises, at a lower end of the discharge outlet, a check valve configured to allow the contents filled in the shape body to move to the discharge outlet and prevent the contents from moving downward,
wherein as the shape body is pressed by an external force, the contents filled in the shape body is discharged to the discharge outlet through the check valve, and when the external force is removed, the shape body is restored and the contents from the contents accommodating container unit are filled again in the shape body.

2. The small-capacity liquid discharging apparatus of claim 1,
wherein the contents accommodating container unit is provided with, thereinside, a support plate configured to support the contents and coupled to an inner circumferential surface of the contents accommodating container unit to be movable up and down in the contents accommodating container unit in accordance with movement of the contents when the contents are discharged upward, and defined with a vent hole at a bottom surface to allow air from being introduced from the outside as the support plate rises.

3. The small-capacity liquid discharging apparatus of claim 2,
wherein a check valve configured to allow air to be introduced and prevents air from being discharged is provided at the vent hole defined at the bottom surface of the contents accommodating container unit.

4. The small-capacity liquid discharging apparatus of claim 2,
wherein a support foot configured to prevent the support plate from moving downward on an inner circumferential surface of the contents accommodating container unit is coupled to a lower portion of the support plate by a coupling member, and
an end portion of the support foot comprises a plurality of end portions which extend radially to contact the inner circumferential surface of the contents accommodating container unit.

5. The small-capacity liquid discharging apparatus of claim 2,
wherein an inner close contact portion which is in close contact with an upper inner side of the contents accommodating container unit is formed at a lower portion of the closing plate member, and
a recess, in a circular shape, corresponding to the inner close contact portion of the closing plate member is defined at an upper circumference of the support plate in a circumferential direction.

6. The small-capacity liquid discharging apparatus of claim 1, wherein the contents accommodating container unit is in a pouch shape of which an internal volume is reduced when the contents are discharged upward.

7. The small-capacity liquid discharging apparatus of claim 1, wherein a check valve configured to allow the contents to move upward and prevents the contents from moving downward is provided at the vent hole defined at the center portion of the closing plate member.

8. The small-capacity liquid discharging apparatus of claim 1,
wherein an upper portion of the contents accommodating container unit and a lower edge of the closing plate member of the intermediate coupling body are formed with respective screw portions to be screwed with each other, and vertical recesses are defined at threads of the screw portions, respectively, so that air between the intermediate coupling body and the contents accommodating container unit is easily discharged to the outside when the intermediate coupling body and the contents accommodating container unit are coupled to each other.

9. The small-capacity liquid discharging apparatus of claim 8,
wherein a concave recess is defined at an upper end of the contents accommodating container unit in a circumferential direction, and a protrusion corresponding to the concave recess is formed at a lower surface of the closing plate member in a circumferential direction so that the protrusion is engaged with the concave recess when coupling between an upper portion of the contents accommodating container unit and a lower edge of the closing plate member of the intermediate coupling body is completed.

10. The small-capacity liquid discharging apparatus of claim 1,
wherein an annular rib is unitarily formed at an inner circumferential surface of the shape body of the intermediate coupling body along a circumferential direction.

11. The small-capacity liquid discharging apparatus of claim 1,
wherein an upper cap is coupled to an upper portion of the discharge member to be opened and closed, and
a sealing member, in a circular shape, configured to seal the discharge outlet by being inserted into the discharge outlet of the discharge member when the discharge member is coupled to the upper cap, is coupled to a center portion of a lower surface of the upper cap so as to prevent the contents of the contents accommodating container unit from being discharged to the outside due to a pressure change.

12. The small-capacity liquid discharging apparatus of claim 1,
wherein the shape body is coupled to an upper edge of the closing plate member and is formed in a cylindrical shape, thus capable of being pressed in all directions.

13. The small-capacity liquid discharging apparatus of claim 1,
wherein a flow tube configured to guide the contents to move toward the discharge outlet of the discharge member is provided at an upper portion of the closing plate member in the shape body of the intermediate coupling body, and
a flow hole which allows the contents to move into and out of the flow tube is defined at an outer circumferential surface of the flow tube.

14. The small-capacity liquid discharging apparatus of claim 13,
wherein a support leg extending from an inner circumferential surface of the shape body to the flow hole of the flow tube is unitarily formed with the shape body, and
the support leg closes the flow hole of the flow tube in a normal state, and when the shape body is pressed by an external force, the support leg is separated from the flow hole so that the contents flow through the flow hole.

15. The small-capacity liquid discharging apparatus of claim 13,
wherein an opening and closing portion configured to open and close the flow hole is provided, the opening and closing portion coupled to an outer circumferential surface of the flow tube,
the opening and closing portion comprises an opening and closing member rotatably coupled to the outer circumferential surface of the flow tube to open and close the flow hole, and a handle of which one end portion is coupled to the opening and closing member and of which another end portion extends to be exposed to the outside of the small-capacity liquid discharging apparatus, and
the flow hole of the flow tube is opened and closed by rotation of the handle.

16. The small-capacity liquid discharging apparatus of claim 15,
wherein the flow hole comprises a plurality of flow holes along a circumferential direction of the flow tube, and
the number of the plurality of flow holes, defined along the circumferential direction of the flow tube, that are opened by the opening and closing member is changed according to a rotation angle of the handle.

17. The small-capacity liquid discharging apparatus of claim 13, wherein the shape body is coupled to one side of an outer circumferential surface of the intermediate coupling body and communicates with the flow hole of the flow tube.

18. The small-capacity liquid discharging apparatus of claim 17, wherein an outer circumferential surface of the shape body comprises a corrugated pipe.

19. The small-capacity liquid discharging apparatus of claim 17,
wherein an adjustment cover is coupled to an outer portion of the shape body,
a guide recess for guiding the adjustment cover to move inwardly is defined at the intermediate coupling body to which the shape body is coupled to, and
a coupling protrusion formed at one side of an outer circumferential surface of the adjustment cover moves along the guide recess.

20. The small-capacity liquid discharging apparatus of claim 19,
wherein a rotation recess extending along a circumferential direction of the shape body is connected to a front end of the guide recess so as to rotate the adjustment cover, and
when the apparatus is not in use, the coupling protrusion of the adjustment cover is separated from the guide recess to be located at the rotation recess so as to prevent the adjustment cover from moving inward.
